(19) United States
(12) Patent Application Publication
(10) Pub. No.: US 2018/0350013 A1
(43) Pub. Date: Dec. 6, 2018

(54) Transaction-Driven Lodging Provider Classification Method And System

(71) Applicant: Visa International Service Association, San Francisco, CA (US)

(72) Inventors: Kebin Lu, Dublin, CA (US); Debesh Kumar, San Mateo, CA (US); Guangyu Wang, Danville, CA (US)

(21) Appl. No.: 15/611,064

(22) Filed: Jun. 1, 2017

(51) Int. Cl. G06Q 50/12; G06Q 30/02

(52) U.S. Cl. CPC G06Q 50/12; G06Q 30/0204

(57) ABSTRACT

Described are a method and system for automatically generating a classification of at least one lodging provider and acting thereon. The method includes determining or receiving transaction data representative of a plurality of transactions between the at least one lodging provider and a plurality of financial device holders in a first time period. The method also includes assigning, based at least partially on a predictive model and the transaction data, a classification to the at least one lodging provider, the classification being selected from a plurality of predetermined classifications. The method further includes generating, based at least partially on the assigned classification, identification data of at least one financial device holder of the plurality of financial device holders. The method further includes automatically generating and transmitting at least one communication to the at least one financial device holder.

### BACKGROUND OF THE INVENTION

### Field of the Invention

Disclosed embodiments or aspects relate generally to a system and method for automatically generating a classification of a lodging provider and, in preferred and non-limiting embodiments or aspects, acting thereon to transmit communications, enroll financial device holders in incentive programs, and/or suspend activities associated with financial device accounts.

### Technical Considerations

In the lodging industry, lodging providers (e.g., hotels, motels, inns, resorts, etc.) are often stratified into different lodging provider classes based on one or more competitive parameters, such as cost of lodging, amenities, quality of staff, quality of rooms, location, and/or the like. Lodging providers are most often designated with a lodging provider class based on individual, subjective evaluation. For example, one or more personnel may physically visit a lodging provider location and inspect the rooms, sample the amenities, and interact with the staff. Afterwards, based on a personal opinion decided from largely qualitative evaluation criteria, the lodging provider may be designated with a lodging provider class. The chosen lodging provider class is often provided to the lodging provider in tandem with the lodging provider purchasing a data and benchmarking system. Lodging providers have a vested competitive interest in understanding their lodging provider class, particularly to compare their performance against similarly classified competitors in the same region. Lodging providers can use their class to help inform their business practices and more accurately target consumers.

Given that lodging provider classification is frequently conducted by individuals employing a subjective evaluation, classification is open to human error and variance. In that regard, two rating services may employ distinct evaluation criteria and return vastly different classifications. Moreover, given that the widest-used, most reliable personnel-based classifications are provided in tandem with the purchase of data and benchmarking systems, smaller or less profitable lodging providers may not be able to afford the services. Furthermore, lodging providers that know their lodging provider classification may still not have the consumer data to efficiently leverage knowledge about their regional competitiveness.

Therefore, there is a need in the art for a system to automatically and reliably classify lodging providers using quantitative data. There is a further need in the art to provide lodging provider classifications without physical personnel interaction or subjective opinion. There is a further need in the art to couple the class designation with consumer data to allow lodging providers to more efficiently make use of their classification.

### SUMMARY OF THE INVENTION

Accordingly, and generally, provided is a method and system for automatically generating a classification of at least one lodging provider and acting thereon. Preferably provided is a method and system for determining or receiving transaction data representative of a plurality of transactions between the at least one lodging provider and a plurality of financial device holders. Preferably provided is a method and system for assigning, based at least partially on a predictive model and the transaction data, a classification to the at least one lodging provider. Preferably provided is a method and system for generating, based at least partially on the assigned classification, identification data of at least one financial device holder of the plurality of financial device holders. Preferably provided is a method and system for automatically generating and transmitting at least one communication to the at least one financial device holder.

According to one preferred and non-limiting embodiment or aspect, provided is a computer-implemented method for automatically generating a classification of at least one lodging provider and acting thereon. The method includes (a) determining or receiving, with at least one processor, transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The method also includes (b) assigning, with at least one processor and based at least partially on a predictive model and the transaction data, a classification to the at least one lodging provider. The classification is selected from a plurality of predetermined classifications. The method further includes (c) generating, with at least one processor and based at least partially on the assigned classification, identification data of at least one financial device holder of the plurality of financial device holders. The method further includes (d) automatically generating and transmitting, with at least one processor, at least one communication to the at least one financial device holder.

In further preferred and non-limiting embodiments or aspects, the computer-implemented method may include (e) determining or receiving, with at least one processor, new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The method may also include (f) assigning, with at least one processor and based at least partially on the predictive model and the new transaction data, a new classification to the at least one lodging provider. The new classification may be selected from the plurality of predetermined classifications. The method may further include (g) comparing, with at least one processor, the new classification to the previously assigned classification. The method may further include (h) modifying, with at least one processor and based at least partially on the comparison, at least one of the following: the predictive model; an identity of the at least one financial device holder to be transmitted the at least one communication; content of the at least one communication; or any combination thereof.

In further preferred and non-limiting embodiments or aspects, step (h) may include modifying the identity of the at least one financial device holder to be transmitted the at least one communication and/or the content of the at least one communication. The method may also include (i) automatically generating and transmitting, with at least one processor, at least one new communication to the at least one financial device holder. The method may further include repeating steps (e)-(i) at configurable intervals. The at least one communication may be a suspension notice communication representative of a suspension of at least one activity associated with at least one financial device of the at least one financial device holder, the at least one activity including at least one of the following: a transaction of a prohibited type; a transaction of a prohibited amount; a transaction with a prohibited merchant; or any combination thereof. The plurality of predetermined classifications may include at least one of the following: economy class; midscale class; upper midscale class; upscale class; upper upscale class; luxury class; or any combination thereof.

In further preferred and non-limiting embodiments or aspects, step (b) may include determining, with at least one processor, a total purchase volume of the at least one lodging provider in the first time period. Step (b) may also include determining, with at least one processor, a consumer credit purchase volume of the at least one lodging provider in the first time period. Step (b) may further include determining, with at least one processor and based on a proportion of the consumer credit purchase volume relative to the total purchase volume, a percent consumer credit purchase volume. Step (b) may further include assigning, with at least one processor and based at least partially on the percent consumer credit purchase volume, the classification to the at least one lodging provider.

In further preferred and non-limiting embodiments or aspects, step (b) may include determining, with at least one processor, a total purchase volume of the at least one lodging provider in the first time period. Step (b) may also include determining, with at least one processor, a premium financial device purchase volume of the at least one lodging provider in the first time period. Step (b) may further include determining, with at least one processor and based on a proportion of the premium financial device purchase volume relative to the total purchase volume, a percent premium financial device purchase volume. Step (b) may further include assigning, with at least one processor and based at least partially on the percent premium financial device purchase volume, the classification to the at least one lodging provider.

In further preferred and non-limiting embodiments or aspects, step (b) may include determining, with at least one processor, a total purchase volume of the at least one lodging provider in the first time period. Step (b) may also include determining, with at least one processor, a total number of transactions of the at least one lodging provider in the first time period. Step (b) may further include determining, with at least one processor and based on a proportion of the total purchase volume relative to the total number of transactions, an average transaction amount. Step (b) may further include assigning, with at least one processor and based at least partially on the average transaction amount, the classification to the at least one lodging provider.

According to one preferred and non-limiting embodiment or aspect, provided is a computer-implemented method for automatically generating a classification of at least one lodging provider and acting thereon. The method includes (a) determining or receiving, with at least one processor, transaction data representative of a plurality of transactions between the at least one lodging provider and a plurality of financial device holders in a first time period. The transaction data includes at least one of the following: transaction consumer credit data, premium transaction device data, transaction amount data, or any combination thereof. The method also includes (b) assigning, with at least one processor and based at least partially on a predictive model and the transaction data, a classification to the at least one lodging provider. The classification is selected from a plurality of predetermined classifications. The method further includes (c) generating, with at least one processor and based at least partially on the assigned classification, identification data of at least one financial device holder of the plurality of financial device holders. The method further includes (d) automatically enrolling, with at least one processor, the at least one financial device holder in at least one incentive program.

In further preferred and non-limiting embodiments or aspects, the method may include (e) determining or receiving, with at least one processor, new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The method may also include (f) assigning, with at least one processor and based at least partially on the predictive model and the new transaction data, a new classification to the at least one lodging provider. The new classification may be selected from the plurality of predetermined classifications. The method may further include (g) comparing, with at least one processor, the new classification to the previously assigned classification. The method may further include (h) modifying, with at least one processor and based at least partially on the comparison, at least one of the following: the predictive model; an identity of the at least one financial device holder to be enrolled in the at least one incentive program; the at least one incentive program; or any combination thereof.

In further preferred and non-limiting embodiments or aspects, step (h) may include modifying the at least one incentive program and/or the identity of the at least one financial device holder to be enrolled in the at least one incentive program. The method may include (i) automatically enrolling or unenrolling, with at least one processor, the at least one financial device holder in the at least one incentive program. The method may also include repeating steps (e)-(i) at configurable intervals. The plurality of predetermined classifications may include at least one of the following: economy class; midscale class; upper midscale class; upscale class; upper upscale class; luxury class; or any combination thereof.

According to one preferred and non-limiting embodiment or aspect, provided is a computer-implemented method for automatically generating a classification of at least one lodging provider and acting thereon. The method includes (a) determining or receiving, with at least one processor, transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The method also includes (b) assigning, with at least one processor and based at least partially on a predictive model and the transaction data, a classification to the at least one lodging provider. The classification is selected from a plurality of predetermined classifications. The method further includes (c) generating, with at least one processor and based at least partially on the assigned classification, identification data of at least one financial device holder of the plurality of financial device holders, the at least one financial device holder having a user-associated classification that is different from the assigned classification. The method further includes (d) automatically initiating, with at least one processor, at least one security action including at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

In further preferred and non-limiting embodiments or aspects, the method may include (e) determining or receiving, with at least one processor, new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The method may also include (f) assigning, with at least one processor and based at least partially on the predictive model and the new transaction data, a new classification to the at least one lodging provider. The new classification may be selected from the plurality of predetermined classifications. The method may further include (g) comparing, with at least one processor, the new classification to the previously assigned classification. The method may further include (h) modifying, with at least one processor and based at least partially on the comparison, at least one of the following: the predictive model; an identity of the at least one financial device holder to have an associated financial device suspended; the user-associated classification; a parameter or status of a suspension of the at least one financial device; or any combination thereof.

In further preferred and non-limiting embodiments or aspects, step (h) may include modifying the identity of the at least one financial device holder to have an associated financial device suspended and/or the parameter or status of a suspension of the at least one financial device. The method may also include (i) automatically suspending or unsuspending, with at least one processor, at least one activity of the at least one financial device of the at least one financial device holder. The method may further include repeating steps (e)-(i) at configurable intervals. The plurality of predetermined classifications may include at least one of the following: economy class; midscale class; upper midscale class; upscale class; upper upscale class; luxury class; or any combination thereof. The at least one activity to be suspended may include at least one of the following: a transaction of a prohibited type; a transaction of a prohibited amount; a transaction with a prohibited merchant; or any combination thereof.

According to one preferred and non-limiting embodiment or aspect, provided is a system for automatically generating a classification of at least one lodging provider and acting thereon. The system includes at least one server computer including at least one processor. The at least one server computer is programmed and/or configured to (a) determine or receive transaction data representative of a plurality of transactions between the at least one lodging provider and a plurality of financial device holders in a first time period. The transaction data includes at least one of the following: transaction consumer credit data; premium transaction device data; transaction amount data, or any combination thereof. The at least one server computer is also programmed and/or configured to (b) assign, based at least partially on a predictive model and the transaction data, a classification to the at least one lodging provider. The classification is selected from a plurality of predetermined classifications. The at least one server computer is further programmed and/or configured to (c) generate, based at least partially on the assigned classification, identification data of at least one financial device holder of the plurality of financial device holders. The at least one server computer is further programmed and/or configured to (d) automatically generate and transmit at least one communication to the at least one financial device holder.

In further preferred and non-limiting embodiments or aspects, the at least one server computer may be programmed and/or configured to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The at least one server computer may also be programmed and/or configured to (f) assign, based at least partially on the predictive model and the new transaction data, a new classification to the at least one lodging provider. The new classification may be selected from the plurality of predetermined classifications. The at least one server computer may further be programmed and/or configured to (g) compare the new classification to the previously assigned classification. The at least one server computer may be further programmed and/or configured to (h) modify, based at least partially on the comparison, at least one of the following: the predictive model; an identity of the at least one financial device holder to be transmitted the at least one communication; content of the at least one communication; or any combination thereof.

In further preferred and non-limiting embodiments or aspects, step (h) may include modifying the identity of the at least one financial device holder to be transmitted the at least one communication and/or the content of the at least one communication. The at least one server computer may be programmed and/or configured to (i) automatically generate and transmit at least one new communication to the at least one financial device holder. The at least one server computer may also be programmed and/or configured to repeat steps (e)-(i) at configurable intervals. The at least one communication may be a suspension notice communication representative of a suspension of at least one activity associated with at least one financial device of the at least one financial device holder, the at least one activity including at least one of the following: a transaction of a prohibited type; a transaction of a prohibited amount; a transaction with a prohibited merchant; or any combination thereof. The plurality of predetermined classifications may include at least one of the following: economy class; midscale class; upper midscale class; upscale class; upper upscale class; luxury class; or any combination thereof.

According to one preferred and non-limiting embodiment or aspect, provided is a system for automatically generating a classification of at least one lodging provider and acting thereon. The system includes at least one server computer including at least one processor. The at least one server computer is programmed and/or configured to (a) determine or receive transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The at least one server computer is also programmed and/or configured to (b) assign, based at least partially on a predictive model and the transaction data, a classification to the at least one lodging provider. The classification is selected from a plurality of predetermined classifications. The at least one server computer is further programmed and/or configured to (c) generate, based at least partially on the assigned classification, identification data of at least one financial device holder of the plurality of financial device holders. The at least one server computer is further programmed and/or configured to (d) automatically enroll the at least one financial device holder in at least one incentive program.

In further preferred and non-limiting embodiments or aspects, the at least one server computer may be programmed and/or configured to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The at least one server computer may also be programmed and/or configured to (f) assign, based at least partially on the predictive model and the new transaction data, a new classification to the at least one lodging provider. The new classification may be selected from the plurality of predetermined classifications. The at least one server computer may be further programmed and/or configured to (g) compare the new classification to the previously assigned classification. The at least one server computer may be further programmed and/or configured to (h) modify, based at least partially on the comparison, at least one of the following: the predictive model, an identity of the at least one financial device holder to be enrolled in the at least one incentive program, the at least one incentive program, or any combination thereof.

In further preferred and non-limiting embodiments or aspects, step (h) may include modifying the at least one incentive program and/or the identity of the at least one financial device holder to be enrolled in the at least one incentive program and/or. The at least one server computer may be programmed and/or configured to (i) automatically enroll or unenroll the at least one financial device holder in the at least one incentive program. The at least one server computer may also be programmed and/or configured to repeat steps (e)-(i) at configurable intervals. The plurality of predetermined classifications may include at least one of the following: economy class; midscale class; upper midscale class; upscale class; upper upscale class; luxury class; or any combination thereof.

In further preferred and non-limiting embodiments or aspects, step (b) may include determining a total purchase volume of the at least one lodging provider in the first time period. Step (b) may also include determining a consumer credit purchase volume of the at least one lodging provider in the first time period. Step (b) may further include determining, based on a proportion of the consumer credit purchase volume relative to the total purchase volume, a percent consumer credit purchase volume. Step (b) may further include assigning, based at least partially on the percent consumer credit purchase volume, the classification to the at least one lodging provider.

In further preferred and non-limiting embodiments or aspects, step (b) may include determining a total purchase volume of the at least one lodging provider in the first time period. Step (b) may also include determining a premium financial device purchase volume of the at least one lodging provider in the first time period. Step (b) may further include determining, based on a proportion of the premium financial device purchase volume relative to the total purchase volume, a percent premium financial device purchase volume. Step (b) may further include assigning, based at least partially on the percent premium financial device purchase volume, the classification to the at least one lodging provider.

In further preferred and non-limiting embodiments or aspects, step (b) may include determining a total purchase volume of the at least one lodging provider in the first time period. Step (b) may also include determining a total number of transactions of the at least one lodging provider in the first time period. Step (b) may further include determining, based on a proportion of the total purchase volume relative to the total number of transactions, an average transaction amount. Step (b) may further include assigning, based at least partially on the average transaction amount, the classification to the at least one lodging provider.

According to one preferred and non-limiting embodiment or aspect, provided is a system for automatically generating a classification of at least one lodging provider and acting thereon. The system includes at least one server computer including at least one processor. The at least one server computer is programmed and/or configured to (a) determine or receive transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The at least one server computer is also programmed and/or configured to (b) assign, based at least partially on a predictive model and the transaction data, a classification to the at least one lodging provider. The classification is selected from a plurality of predetermined classifications. The at least one server computer is further programmed and/or configured to (c) generate, based at least partially on the assigned classification, identification data of at least one financial device holder of the plurality of financial device holders, the at least one financial device holder having a user-associated classification that is different from the assigned classification. The at least one server computer is further programmed and/or configured to (d) automatically initiate at least one security action including at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

In further preferred and non-limiting embodiments or aspects, the at least one server computer may be programmed and/or configured to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The at least one server computer may also be programmed and/or configured to (f) assign, based at least partially on the predictive model and the new transaction data, a new classification to the at least one lodging provider. The new classification may be selected from the plurality of predetermined classifications. The at least one server computer may be further programmed and/or configured to (g) compare the new classification to the previously assigned classification. The at least one server computer may be further programmed and/or configured to (h) modify, based at least partially on the comparison, at least one of the following: the predictive model; an identity of the at least one financial device holder to have an associated financial device suspended; the user-associated classification; a parameter or status of a suspension of the at least one financial device; or any combination thereof.

In further preferred and non-limiting embodiments or aspects, step (h) may include modifying the identity of the at least one financial device holder to have an associated financial device suspended and/or the parameter or status of a suspension of the at least one financial device. The at least one server computer may be further programmed and/or configured to (i) automatically suspend or unsuspend, with at least one processor, at least one activity of the at least one financial device of the at least one financial device holder. The at least one server computer may be further programmed and/or configured to repeat steps (e)-(i) at configurable intervals. The plurality of predetermined classifications may include at least one of the following: economy class; midscale class; upper midscale class; upscale class; upper upscale class; luxury class; or any combination thereof. The at least one activity to be suspended may include at least one of the following: a transaction of a prohibited type; a transaction of a prohibited amount; a transaction with a prohibited merchant; or any combination thereof.

According to one preferred and non-limiting embodiment or aspect, provided is a computer program product for automatically generating a classification of at least one lodging provider and acting thereon. The computer program product includes at least one non-transitory computer-readable medium including program instructions. The program instructions, when executed by at least one processor, cause the at least one processor to (a) determine or receive transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The program instructions also cause the at least one processor to (b) assign, based at least partially on a predictive model and the transaction data, a classification to the at least one lodging provider. The classification is selected from a plurality of predetermined classifications. The program instructions further cause the at least one processor to (c) generate, based at least partially on the assigned classification, identification data of at least one financial device holder of the plurality of financial device holders. The program instructions further cause the at least one processor to (d) automatically generate and transmit at least one communication to the at least one financial device holder.

In further preferred and non-limiting embodiments or aspects, the program instructions may cause the at least one processor to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The program instructions may also cause the at least one processor to (f) assign, based at least partially on the predictive model and the new transaction data, a new classification to the at least one lodging provider. The new classification may be selected from the plurality of predetermined classifications. The program instructions may further cause the at least one processor to (g) compare the new classification to the previously assigned classification. The program instructions may further cause the at least one processor to (h) modify, based at least partially on the comparison, at least one of the following: the predictive model; an identity of the at least one financial device holder to be transmitted the at least one communication; content of the at least one communication; or any combination thereof.

In further preferred and non-limiting embodiments or aspects, step (h) may include modifying the identity of the at least one financial device holder to be transmitted the at least one communication and/or the content of the at least one communication. The program instructions may cause the at least one processor to (i) automatically generate and transmit at least one new communication to the at least one financial device holder. The program instructions may also cause the at least one processor to repeat steps (e)-(i) at configurable intervals. The at least one communication may be a suspension notice communication representative of a suspension of at least one activity associated with at least one financial device of the at least one financial device holder. The at least one activity may include at least one of the following: a transaction of a prohibited type; a transaction of a prohibited amount; a transaction with a prohibited merchant; or any combination thereof. The plurality of predetermined classifications may include at least one of the following: economy class; midscale class; upper midscale class; upscale class; upper upscale class; luxury class; or any combination thereof.

In further preferred and non-limiting embodiments or aspects, step (b) may include determining a total purchase volume of the at least one lodging provider in the first time period. Step (b) may also include determining a consumer credit purchase volume of the at least one lodging provider in the first time period. Step (b) may further include determining, based on a proportion of the consumer credit purchase volume relative to the total purchase volume, a percent consumer credit purchase volume. Step (b) may further include assigning, based at least partially on the percent consumer credit purchase volume, the classification to the at least one lodging provider.

In further preferred and non-limiting embodiments or aspects, step (b) may include determining a total purchase volume of the at least one lodging provider in the first time period. Step (b) may also include determining a premium financial device purchase volume of the at least one lodging provider in the first time period. Step (b) may further include determining, based on a proportion of the premium financial device purchase volume relative to the total purchase volume, a percent premium financial device purchase volume. Step (b) may further include assigning, based at least partially on the percent premium financial device purchase volume, the classification to the at least one lodging provider.

In further preferred and non-limiting embodiments or aspects, step (b) may include determining a total purchase volume of the at least one lodging provider in the first time period. Step (b) may also include determining a total number of transactions of the at least one lodging provider in the first time period. Step (b) may further include determining, based on a proportion of the total purchase volume relative to the total number of transactions, an average transaction amount. Step (b) may further include assigning, based at least partially on the average transaction amount, the classification to the at least one lodging provider.

According to one preferred and non-limiting embodiment or aspect, provided is a computer program product for automatically generating a classification of at least one lodging provider and acting thereon. The computer program product includes at least one non-transitory computer-readable medium including program instructions. The program instructions, when executed by at least one processor, cause the at least one processor to (a) determine or receive transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The program instructions also cause the at least one processor to (b) assign, based at least partially on a predictive model and the transaction data, a classification to the at least one lodging provider. The classification is selected from a plurality of predetermined classifications. The program instructions further cause the at least one processor to (c) generate, based at least partially on the assigned classification, identification data of at least one financial device holder of the plurality of financial device holders. The program instructions further cause the at least one processor to (d) automatically enroll the at least one financial device holder in at least one incentive program.

In further preferred and non-limiting embodiments or aspects, the program instructions may cause the at least one processor to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The program instructions may also cause the at least one processor to (f) assign, based at least partially on the predictive model and the new transaction data, a new classification to the at least one lodging provider. The new classification may be selected from the plurality of predetermined classifications. The program instructions may further cause the at least one processor to (g) compare the new classification to the previously assigned classification. The program instructions may also cause the at least one processor to (h) modify, based at least partially on the comparison, at least one of the following: the predictive model; an identity of the at least one financial device holder to be enrolled in the at least one incentive program; the at least one incentive program; or any combination thereof.

In further preferred and non-limiting embodiments or aspects, step (h) may include modifying the identity of the at least one financial device holder to be enrolled in the at least one incentive program and/or the at least one incentive program. The program instructions may cause the at least one processor to (i) automatically enroll or unenroll the at least one financial device holder in the at least one incentive program. The program instructions may also cause the at least one processor to repeat steps (e)-(i) at configurable intervals. The plurality of predetermined classifications may include at least one of the following: economy class; midscale class; upper midscale class; upscale class; upper upscale class; luxury class; or any combination thereof.

According to one preferred and non-limiting embodiment or aspect, provided is a computer program product for automatically generating a classification of at least one lodging provider and acting thereon. The computer program product includes at least one non-transitory computer-readable medium including program instructions. The program instructions, when executed by at least one processor, cause the at least one processor to (a) determine or receive transaction data representative of a plurality of transactions between the at least one lodging provider and a plurality of financial device holders in a first time period. The transaction data includes at least one of the following: transaction consumer credit data; premium transaction device data; transaction amount data; or any combination thereof. The program instructions also cause the at least one processor to (b) assign, based at least partially on a predictive model and the transaction data, a classification to the at least one lodging provider. The classification is selected from a plurality of predetermined classifications. The program instructions further cause the at least one processor to (c) generate, based at least partially on the assigned classification, identification data of at least one financial device holder of the plurality of financial device holders, the at least one financial device holder having a user-associated classification that is different from the assigned classification. The program instructions further cause the at least one processor to (d) automatically initiate at least one security action including at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

In further preferred and non-limiting embodiments or aspects, the program instructions may cause the at least one processor to (e) determine or receive new transaction data representative of a plurality of transactions between the at least one lodging provider and a plurality of financial device holders in a second time period. The new transaction data may include at least one of the following: transaction consumer credit data; premium transaction device data; transaction amount data; or any combination thereof. The program instructions may also cause the at least one processor to (f) assign, based at least partially on the predictive model and the new transaction data, a new classification to the at least one lodging provider. The new classification may be selected from the plurality of predetermined classifications. The program instructions may further cause the at least one processor to (g) compare the new classification to the previously assigned classification. The program instructions may further cause the at least one processor to (h) modify, based at least partially on the comparison, at least one of the following: the predictive model; an identity of the at least one financial device holder to have an associated financial device suspended; the user-associated classification; a parameter or status of a suspension of the at least one financial device; or any combination thereof.

In further preferred and non-limiting embodiments or aspects, step (h) may include modifying the identity of the at least one financial device holder to have an associated financial device suspended and/or the parameter or status of a suspension of the at least one financial device. The program instructions may cause the at least one processor to (i) automatically suspend or unsuspend, with at least one processor, at least one activity of the at least one financial device of the at least one financial device holder. The program instructions may also cause the at least one processor to repeat steps (e)-(i) at configurable intervals. The plurality of predetermined classifications may include at least one of the following: economy class; midscale class; upper midscale class; upscale class; upper upscale class; luxury class; or any combination thereof. The at least one activity may include at least one of the following: a transaction of a prohibited type; a transaction of a prohibited amount; a transaction with a prohibited merchant; or any combination thereof.

Other preferred and non-limiting embodiments or aspects of the present invention will be set forth in the following numbered clauses.

Clause 1: A computer-implemented method for automatically generating a classification of at least one lodging provider and acting thereon, the method comprising: (a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assigning, with at least one processor and based at least partially on a predictive model and the transaction data, a classification to the at least one lodging provider, the classification being selected from a plurality of predetermined classifications; (c) generating, with at least one processor and based at least partially on the assigned classification, identification data of at least one financial device holder of the plurality of financial device holders; and (d) automatically generating and transmitting, with at least one processor, at least one communication to the at least one financial device holder.

Clause 2: The computer-implemented method of clause 1, further comprising: (e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assigning, with at least one processor and based at least partially on the predictive model and the new transaction data, a new classification to the at least one lodging provider, the new classification being selected from the plurality of predetermined classifications; (g) comparing, with at least one processor, the new classification to the previously assigned classification; and (h) modifying, with at least one processor and based at least partially on the comparison, at least one of the following: the predictive model, an identity of the at least one financial device holder to be transmitted the at least one communication, content of the at least one communication, or any combination thereof.

Clause 3: The computer-implemented method of clause 1 or 2, wherein step (h) comprises modifying the identity of the at least one financial device holder to be transmitted the at least one communication and/or the content of the at least one communication, and wherein the method further comprises (i) automatically generating and transmitting, with at least one processor, at least one new communication to the at least one financial device holder.

Clause 4: The computer-implemented method of any of clauses 1-3, comprising repeating steps (e)-(i) at configurable intervals.

Clause 5: The computer-implemented method of any of clauses 1-4, wherein the at least one communication is a suspension notice communication representative of a suspension of at least one activity associated with at least one financial device of the at least one financial device holder, the at least one activity comprising at least one of the following: a transaction of a prohibited type, a transaction of a prohibited amount, a transaction with a prohibited merchant, or any combination thereof.

Clause 6: The computer-implemented method of any of clauses 1-5, wherein the plurality of predetermined classifications comprises at least one of the following: economy class, midscale class, upper midscale class, upscale class, upper upscale class, luxury class, or any combination thereof.

Clause 7: The computer-implemented method of any of clauses 1-6, wherein step (b) comprises: determining, with at least one processor, a total purchase volume of the at least one lodging provider in the first time period; determining, with at least one processor, a consumer credit purchase volume of the at least one lodging provider in the first time period; determining, with at least one processor and based on a proportion of the consumer credit purchase volume relative to the total purchase volume, a percent consumer credit purchase volume; and assigning, with at least one processor and based at least partially on the percent consumer credit purchase volume, the classification to the at least one lodging provider.

Clause 8: The computer-implemented method of any of clauses 1-7, wherein step (b) comprises: determining, with at least one processor, a total purchase volume of the at least one lodging provider in the first time period; determining, with at least one processor, a premium financial device purchase volume of the at least one lodging provider in the first time period; determining, with at least one processor and based on a proportion of the premium financial device purchase volume relative to the total purchase volume, a percent premium financial device purchase volume; and assigning, with at least one processor and based at least partially on the percent premium financial device purchase volume, the classification to the at least one lodging provider.

Clause 9: The computer-implemented method of any of clauses 1-8, wherein step (b) comprises: determining, with at least one processor, a total purchase volume of the at least one lodging provider in the first time period; determining, with at least one processor, a total number of transactions of the at least one lodging provider in the first time period; determining, with at least one processor and based on a proportion of the total purchase volume relative to the total number of transactions, an average transaction amount; and assigning, with at least one processor and based at least partially on the average transaction amount, the classification to the at least one lodging provider.

Clause 10: A computer-implemented method for automatically generating a classification of at least one lodging provider and acting thereon, the method comprising: (a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assigning, with at least one processor and based at least partially on a predictive model and the transaction data, a classification to the at least one lodging provider, the classification being selected from a plurality of predetermined classifications; (c) generating, with at least one processor and based at least partially on the assigned classification, identification data of at least one financial device holder of the plurality of financial device holders; and (d) automatically enrolling, with at least one processor, the at least one financial device holder in at least one incentive program.

Clause 11: The computer-implemented method of clause 10, further comprising: (e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assigning, with at least one processor and based at least partially on the predictive model and the new transaction data, a new classification to the at least one lodging provider, the new classification being selected from the plurality of predetermined classifications; (g) comparing, with at least one processor, the new classification to the previously assigned classification; and (h) modifying, with at least one processor and based at least partially on the comparison, at least one of the following: the predictive model, an identity of the at least one financial device holder to be enrolled in the at least one incentive program, the at least one incentive program, or any combination thereof.

Clause 12: The computer-implemented method of clause 10 or 11, wherein step (h) comprises modifying the identity of the at least one financial device holder to be enrolled in the at least one incentive program and/or the at least one incentive program, and wherein the method further comprises (i) automatically enrolling or unenrolling, with at least one processor, the at least one financial device holder in the at least one incentive program.

Clause 13: The computer-implemented method of any of clauses 10-12, comprising repeating steps (e)-(i) at configurable intervals.

Clause 14: The computer-implemented method of any of clauses 10-13, wherein the plurality of predetermined classifications comprises at least one of the following: economy class, midscale class, upper midscale class, upscale class, upper upscale class, luxury class, or any combination thereof.

Clause 15: The computer-implemented method of any of clauses 10-14, wherein step (b) comprises: determining, with at least one processor, a total purchase volume of the at least one lodging provider in the first time period; determining, with at least one processor, a consumer credit purchase volume of the at least one lodging provider in the first time period; determining, with at least one processor and based on a proportion of the consumer credit purchase volume relative to the total purchase volume, a percent consumer credit purchase volume; and assigning, with at least one processor and based at least partially on the percent consumer credit purchase volume, the classification to the at least one lodging provider.

Clause 16: The computer-implemented method of any of clauses 10-15, wherein step (b) comprises: determining, with at least one processor, a total purchase volume of the at least one lodging provider in the first time period; determining, with at least one processor, a premium financial device purchase volume of the at least one lodging provider in the first time period; determining, with at least one processor and based on a proportion of the premium financial device purchase volume relative to the total purchase volume, a percent premium financial device purchase volume; and assigning, with at least one processor and based at least partially on the percent premium financial device purchase volume, the classification to the at least one lodging provider.

Clause 17: The computer-implemented method of any of clauses 10-16, wherein step (b) comprises: determining, with at least one processor, a total purchase volume of the at least one lodging provider in the first time period; determining, with at least one processor, a total number of transactions of the at least one lodging provider in the first time period; determining, with at least one processor and based on a proportion of the total purchase volume relative to the total number of transactions, an average transaction amount; and assigning, with at least one processor and based at least partially on the average transaction amount, the classification to the at least one lodging provider.

Clause 18: A computer-implemented method for automatically generating a classification of at least one lodging provider and acting thereon, the method comprising: (a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assigning, with at least one processor and based at least partially on a predictive model and the transaction data, a classification to the at least one lodging provider, the classification being selected from a plurality of predetermined classifications; (c) generating, with at least one processor and based at least partially on the assigned classification, identification data of at least one financial device holder of the plurality of financial device holders, the at least one financial device holder having a user-associated classification that is different from the assigned classification; and (d) automatically initiating, with at least one processor, at least one security action comprising at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

Clause 19: The computer-implemented method of clause 18, further comprising: (e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assigning, with at least one processor and based at least partially on the predictive model and the new transaction data, a new classification to the at least one lodging provider, the new classification being selected from the plurality of predetermined classifications; (g) comparing, with at least one processor, the new classification to the previously assigned classification; and (h) modifying, with at least one processor and based at least partially on the comparison, at least one of the following: the predictive model, an identity of the at least one financial device holder to have an associated financial device suspended, the user-associated classification, a parameter or status of a suspension of the at least one financial device, or any combination thereof.

Clause 20: The computer-implemented method of clause 18 or 19, wherein step (h) comprises modifying the identity of the at least one financial device holder to have an associated financial device suspended and/or the parameter or status of a suspension of the at least one financial device, and wherein the method further comprises (i) automatically suspending or unsuspending, with at least one processor, at least one activity of the at least one financial device of the at least one financial device holder.

Clause 21: The computer-implemented method of any of clauses 18-20, comprising repeating steps (e)-(i) at configurable intervals.

Clause 22: The computer-implemented method of any of clauses 18-21, wherein the plurality of predetermined classifications comprises at least one of the following: economy class, midscale class, upper midscale class, upscale class, upper upscale class, luxury class, or any combination thereof.

Clause 23: The computer-implemented method of any of clauses 18-22, wherein the at least one activity comprises at least one of the following: a transaction of a prohibited type, a transaction of a prohibited amount, a transaction with a prohibited merchant, or any combination thereof.

Clause 24: The computer-implemented method of any of clauses 18-23, wherein step (b) comprises: determining, with at least one processor, a total purchase volume of the at least one lodging provider in the first time period; determining, with at least one processor, a consumer credit purchase volume of the at least one lodging provider in the first time period; determining, with at least one processor and based on a proportion of the consumer credit purchase volume relative to the total purchase volume, a percent consumer credit purchase volume; and assigning, with at least one processor and based at least partially on the percent consumer credit purchase volume, the classification to the at least one lodging provider.

Clause 25: The computer-implemented method of any of clauses 18-24, wherein step (b) comprises: determining, with at least one processor, a total purchase volume of the at least one lodging provider in the first time period; determining, with at least one processor, a premium financial device purchase volume of the at least one lodging provider in the first time period; determining, with at least one processor and based on a proportion of the premium financial device purchase volume relative to the total purchase volume, a percent premium financial device purchase volume; and assigning, with at least one processor and based at least partially on the percent premium financial device purchase volume, the classification to the at least one lodging provider.

Clause 26: The computer-implemented method of any of clauses 18-25, wherein step (b) comprises: determining, with at least one processor, a total purchase volume of the at least one lodging provider in the first time period; determining, with at least one processor, a total number of transactions of the at least one lodging provider in the first time period; determining, with at least one processor and based on a proportion of the total purchase volume relative to the total number of transactions, an average transaction amount; and assigning, with at least one processor and based at least partially on the average transaction amount, the classification to the at least one lodging provider.

Clause 27: A system for automatically generating a classification of at least one lodging provider and acting thereon, comprising at least one server computer including at least one processor, the at least one server computer programmed and/or configured to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders; and (d) automatically generate and transmit at least one communication to the at least one financial device holder.

Clause 28: The system of clause 27, wherein the at least one server computer is further programmed and/or configured to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to be transmitted the at least one communication, content of the at least one communication, or any combination thereof.

Clause 29: The system of clause 27 or 28, wherein step (h) comprises modifying the identity of the at least one financial device holder to be transmitted the at least one communication and/or the content of the at least one communication, and wherein the at least one server computer is further programmed and/or configured to (i) automatically generate and transmit at least one new communication to the at least one financial device holder.

Clause 30: The system of any of clauses 27-29, wherein the at least one server computer is further programmed and/or configured to repeat steps (e)-(i) at configurable intervals.

Clause 31: The system of any of clauses of 27-30, wherein the at least one communication is a suspension notice communication representative of a suspension of at least one activity associated with at least one financial device of the at least one financial device holder, the at least one activity comprising at least one of the following: a transaction of a prohibited type, a transaction of a prohibited amount, a transaction with a prohibited merchant, or any combination thereof.

Clause 32: The system of any of clauses 27-31, wherein the plurality of predetermined classifications comprises at least one of the following: economy class, midscale class, upper midscale class, upscale class, upper upscale class, luxury class, or any combination thereof.

Clause 33: The system of any of clauses 27-32, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 34: The system of any of clauses 27-33, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 35: The system of any of clauses 27-34, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

Clause 36: A system for automatically generating a classification of at least one lodging provider and acting thereon, comprising at least one server computer including at least one processor, the at least one server computer programmed and/or configured to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders; and (d) automatically enroll the at least one financial device holder in at least one incentive program.

Clause 37: The system of clause 36, wherein the at least one server computer is further programmed and/or configured to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to be enrolled in the at least one incentive program, the at least one incentive program, or any combination thereof.

Clause 38: The system of clause 36 or 37, wherein step (h) comprises modifying the at least one incentive program and/or the identity of the at least one financial device holder to be enrolled in the at least one incentive program, and wherein the at least one server computer is further programmed and/or configured to (i) automatically enroll or unenroll the at least one financial device holder in the at least one incentive program.

Clause 39: The system of any of clauses 36-38, wherein the at least one server computer is further programmed and/or configured to repeat steps (e)-(i) at configurable intervals.

Clause 40: The system of any of clauses 36-39, wherein the plurality of predetermined classifications comprises at least one of the following: economy class, midscale class, upper midscale class, upscale class, upper upscale class, luxury class, or any combination thereof.

Clause 41: The system of any of clauses 36-40, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 42: The system of any of clauses 36-41, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 43: The system of any of clauses 36-42, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

Clause 44: A system for automatically generating a classification of at least one lodging provider and acting thereon, comprising at least one server computer including at least one processor, the at least one server computer programmed and/or configured to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders, the at least one financial device holder having a user-associated classification that is different from the assigned classification; and (d) automatically initiate at least one security action comprising at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

Clause 45: The system of clause 44, wherein the at least one server computer is further programmed and/or configured to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to have an associated financial device suspended, the user-associated classification, a parameter or status of a suspension of the at least one financial device, or any combination thereof.

Clause 46: The system of clause 44 or 45, wherein step (h) comprises modifying the identity of the at least one financial device holder to have an associated financial device suspended and/or the parameter or status of a suspension of the at least one financial device, and wherein the at least one server computer is further programmed and/or configured to (i) automatically suspend or unsuspend, with at least one processor, at least one activity of the at least one financial device of the at least one financial device holder.

Clause 47: The system of any of clauses 44-46, wherein the at least one server computer is further programmed and/or configured to repeat steps (e)-(i) at configurable intervals.

Clause 48: The system of any of clauses 44-47, wherein the plurality of predetermined classifications comprises at least one of the following: economy class, midscale class, upper midscale class, upscale class, upper upscale class, luxury class, or any combination thereof.

Clause 49: The system of any of clauses 44-48, wherein the at least one activity comprises at least one of the following: a transaction of a prohibited type, a transaction of a prohibited amount, a transaction with a prohibited merchant, or any combination thereof.

Clause 50: The system of any of clauses 44-49, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 51: The system of any of clauses 44-50, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 52: The system of any of clauses 44-51, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

Clause 53: A computer program product for automatically generating a classification of at least one lodging provider and acting thereon, comprising at least one non-transitory computer-readable medium including program instructions that, when executed by at least one processor, cause the at least one processor to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders; and (d) automatically generate and transmit at least one communication to the at least one financial device holder.

Clause 54: The computer program product of clause 53, wherein the program instructions further cause the at least one processor to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to be transmitted the at least one communication, content of the at least one communication, or any combination thereof.

Clause 55: The computer program product of clause 53 or 54, wherein step (h) comprises modifying the identity of the at least one financial device holder to be transmitted the at least one communication and/or the content of the at least one communication, and wherein the program instructions further cause the at least one processor to (i) automatically generate and transmit at least one new communication to the at least one financial device holder.

Clause 56: The computer program product of any of clauses 53-55, wherein the program instructions further cause the at least one processor to repeat steps (e)-(i) at configurable intervals.

Clause 57: The computer program product of any of clauses of 53-56, wherein the at least one communication is a suspension notice communication representative of a suspension of at least one activity associated with at least one financial device of the at least one financial device holder, the at least one activity comprising at least one of the following: a transaction of a prohibited type, a transaction of a prohibited amount, a transaction with a prohibited merchant, or any combination thereof.

Clause 58: The computer program product of any of clauses 53-57, wherein the plurality of predetermined classifications comprises at least one of the following: economy class, midscale class, upper midscale class, upscale class, upper upscale class, luxury class, or any combination thereof.

Clause 59: The computer program product of any of clauses 53-58, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 60: The computer program product of any of clauses 53-59, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 61: The computer program product of any of clauses 53-60, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

Clause 62: A computer program product for automatically generating a classification of at least one lodging provider and acting thereon, comprising at least one non-transitory computer-readable medium including program instructions that, when executed by at least one processor, cause the at least one processor to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders; and (d) automatically enroll the at least one financial device holder in at least one incentive program.

Clause 63: The computer program product of clause 62, wherein the program instructions further cause the at least one processor to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to be enrolled in the at least one incentive program, the at least one incentive program, or any combination thereof.

Clause 64: The computer program product of clause 62 or 63, wherein step (h) comprises modifying the at least one incentive program and/or the identity of the at least one financial device holder to be enrolled in the at least one incentive program, and wherein the program instructions further cause the at least one processor to (i) automatically enroll or unenroll the at least one financial device holder in the at least one incentive program.

Clause 65: The computer program product of any of clauses 62-64, wherein the program instructions further cause the at least one processor to repeat steps (e)-(i) at configurable intervals.

Clause 66: The computer program product of any of clauses 62-65, wherein the plurality of predetermined classifications comprises at least one of the following: economy class, midscale class, upper midscale class, upscale class, upper upscale class, luxury class, or any combination thereof.

Clause 67: The computer program product of any of clauses 62-66, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 68: The computer program product of any of clauses 62-67, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 69: The computer program product of any of clauses 62-68, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

Clause 70: A computer program product for automatically generating a classification of at least one lodging provider and acting thereon, comprising at least one non-transitory computer-readable medium including program instructions that, when executed by at least one processor, cause the at least one processor to: (a) determine or receive transaction data representative of a plurality of transactions between the at least one lodging provider and a plurality of financial device holders in a first time period, the transaction data comprising at least one of the following: transaction consumer credit data, premium transaction device data, transaction amount data, or any combination thereof; (b) assign, based at least partially on a predictive model and the transaction data, a classification to the at least one lodging provider, the classification being selected from a plurality of predetermined classifications; (c) generate, based at least partially on the assigned classification, identification data of at least one financial device holder of the plurality of financial device holders, the at least one financial device holder having a user-associated classification that is different from the assigned classification; and (d) automatically initiate at least one security action comprising at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

Clause 71: The computer program product of clause 70, wherein the program instructions further cause the at least one processor to: (e) determine or receive new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof; (f) assign, based at least partially on the predictive model and the new transaction data, a new classification to the at least one lodging provider, the new classification being selected from the plurality of predetermined classifications; (g) compare the new classification to the previously assigned classification; and (h) modify, based at least partially on the comparison, at least one of the following: the predictive model, an identity of the at least one financial device holder to have an associated financial device suspended, the user-associated classification, a parameter or status of a suspension of the at least one financial device, or any combination thereof.

Clause 72: The computer program product of clause 70 or 71, wherein step (h) comprises modifying the identity of the at least one financial device holder to have an associated financial device suspended and/or the parameter or status of a suspension of the at least one financial device, and wherein the program instructions further cause the at least one processor to (i) automatically suspend or unsuspend, with at least one processor, at least one activity of the at least one financial device of the at least one financial device holder.

Clause 73: The computer program product of any of clauses 70-72, wherein the program instructions further cause the at least one processor to repeat steps (e)-(i) at configurable intervals.

Clause 74: The computer program product of any of clauses 70-73, wherein the plurality of predetermined classifications comprises at least one of the following: economy class, midscale class, upper midscale class, upscale class, upper upscale class, luxury class, or any combination thereof.

Clause 75: The computer program product of any of clauses 70-74, wherein the at least one activity comprises at least one of the following: a transaction of a prohibited type, a transaction of a prohibited amount, a transaction with a prohibited merchant, or any combination thereof.

Clause 76: The computer program product of any of clauses 70-75, wherein step (b) comprises: determining a total purchase volume of the at least one lodging provider in the first time period; determining a consumer credit purchase volume of the at least one lodging provider in the first time period; determining, based on a proportion of the consumer credit purchase volume relative to the total purchase volume, a percent consumer credit purchase volume; and assigning, based at least partially on the percent consumer credit purchase volume, the classification to the at least one lodging provider.

Clause 77: The computer program product of any of clauses 70-76, wherein step (b) comprises: determining a total purchase volume of the at least one lodging provider in the first time period; determining a premium financial device purchase volume of the at least one lodging provider in the first time period; determining, based on a proportion of the premium financial device purchase volume relative to the total purchase volume, a percent premium financial device purchase volume; and assigning, based at least partially on the percent premium financial device purchase volume, the classification to the at least one lodging provider.

Clause 78: The computer program product of any of clauses 70-77, wherein step (b) comprises: determining a total purchase volume of the at least one lodging provider in the first time period; determining a total number of transactions of the at least one lodging provider in the first time period; determining, based on a proportion of the total purchase volume relative to the total number of transactions, an average transaction amount; and assigning, based at least partially on the average transaction amount, the classification to the at least one lodging provider.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic diagram of one embodiment or aspect of a method and system for automatically generating a classification of at least one lodging provider and acting thereon;

FIG. 2 is a schematic diagram of one embodiment or aspect of a method and system for automatically generating a classification of at least one lodging provider and acting thereon;

FIG. 3 is a process diagram of one embodiment or aspect of a method and system for automatically generating a classification of at least one lodging provider and acting thereon; and

FIG. 4 is a process diagram of one embodiment or aspect of a method and system for automatically generating a classification of at least one lodging provider and acting thereon.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and process illustrated in the attached drawings, and described in the following specification, are simply exemplary embodiments of the invention. Hence, specific dimensions and other physical characteristics related to the embodiments disclosed herein are not to be considered as limiting. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “issuer institution” may refer to one or more entities, such as a bank, that provides accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. As used herein, the term “account identifier” may include one or more PANs, tokens, or other identifiers associated with a customer account. An account identifier may be directly or indirectly associated with an issuer institution, such that an account identifier may be a token that maps to a PAN or other type of account identifier. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifiers in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions. The terms “issuer institution”, “issuer bank”, and “issuer system” may also refer to one or more computer systems operated by or on behalf of an issuer institution, such as a server computer executing one or more software applications. For example, an issuer system may include one or more authorization servers for authorizing a payment transaction.

As used herein, the term “merchant” refers to any individual or entity that provides goods, and/or services, or access to goods and/or services, to customers based on a transaction, such as a payment transaction. Merchants may include, but are not limited to, restaurants, food trucks, clubs, gymnasiums, retail stores, professional services providers (e.g., dentists, doctors, plumbers, etc.), parks, museums, lodging providers, attractions, sporting venues, and/or the like. It will be appreciated that numerous other types of merchants are within the scope of this invention. As used herein, the term “lodging provider” refers to any merchant providing shelter to one or more individuals in return for payment. Lodging providers may include, but are not limited to, hotels, hostels, motels, chalets, lodges, resorts, camps, bed-and-breakfasts, inns, pensions, and/or the like. It will be appreciated that numerous other types of lodging providers are within the scope of this invention. As used herein, “lodging provider classification” refers to any categorical designation of a hotel determined by one or more parameters of a lodging provider. Lodging provider classification may be arranged according to a tier system and may include, but is not limited to, economy class, midscale class, upper midscale class, upscale class, upper upscale class, luxury class, and/or the like. Such lodging provider classifications may be aligned with the level of services a lodging provider property provides, and, therefore, it may also be associated with targeted customers, property location selection, marketing, pricing strategy, and/or the like. For example, “luxury class” may be a top tier classification, and the lodging provider properties classified within that tier are often built on premium or highly desired locations and have full scale services and a rich selection of amenities, such as concierge services, high quality restaurants and lounges, valet, private dining facilities, and/or the like. “Luxury class” lodging providers often target top business executives, entertainment celebrities, high-ranking political figures, and wealthy clientele as their primary markets. Daily room rates for “luxury class” lodging providers are the highest and may run at several hundreds or even thousands of U.S. dollars. It will be appreciated that the other lodging provider classifications may be similarly determined at stratifications of quality and cost at progressively lower tiers. Lodging provider parameters that may be used to determine a classification include, but are not limited to, financial device transaction data (e.g., transaction amount, consumer credit data, small business credit data, premium financial device data, average transaction amounts, etc.), quality of services and products, geolocation, amenities, and/or the like.

As used herein, the term “financial device” may refer to a portable (e.g., physical) payment card, a gift card, a smartcard, a smart media, a payroll card, a healthcare card, a wrist band, a machine-readable medium containing account information, a keychain device, a supermarket discount card, a cellular phone, a mobile device, a personal digital assistant, a pager, a security card, a computer, an access card, a wireless terminal, or a transponder. The financial device may include a volatile or a non-volatile memory to store information, such as the account number or a name of the account holder. The term “financial device” may also refer to any unique identifier, physical or digital, associated with a financial transaction account that can be used to complete a transaction between a user of the financial device and another party, such as a merchant. For example, a financial device may be a financial transaction account number and confirmation code that may be entered into an online store payment interface. As used herein, the term “premium financial device” may refer to a financial device that has heightened financial requirements or heightened financial responsibility for a financial device holder to acquire and/or hold the card. The term “premium financial device” may also refer to a financial device associated with a benefits or rewards program that incentivizes or provides a returned value for use of the financial device. It will be appreciated that many other configurations and embodiments are possible.

As used herein, the term “merchant system” may refer to one or more server computers, point-of-sale devices, online interfaces, third party hosted services, and/or the like that are used to complete transactions by a merchant, such as a lodging provider, with one or more financial devices. The term merchant system may also refer to one or more server computers, processors, online interfaces, third party hosted services, and/or the like that are used to transmit and/or receive communications with issuer institutions, transaction service providers, transaction processing servers, financial device holders, and/or the like.

As used herein, the term “transaction service provider” may refer to an entity that collects authorization requests from merchants and provides guarantees of payment, in some cases through an agreement between the transaction service provider and an issuer institution. As used herein, the term “recurring transactions” may refer to any series of repeated or patterned transactions between a financial device and a merchant. Recurring transactions are often regular and of a similar amount but do not need to be identical in cost or identical in purchased goods/services to be recurring.

As used herein, the term “mobile device” may refer to one or more portable electronic devices that are configured to communicate with one or more networks. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices.

Non-limiting embodiments or aspects of the present invention are directed to automatically generating a classification of one or more lodging providers and acting thereon, such as generating and transmitting communications to specified consumers, enacting security protocols, and/or implementing incentive programs. Embodiments or aspects of the present invention provide a system, including at least one server computer, to determine or receive transaction data and identify a lodging provider classification based on an automated predictive model and the transaction data. The system of the present invention provides for automated classification of lodging providers, without the need for human inspection or interaction of personnel. Embodiments or aspects of the present invention improve upon existing systems, which are subjective, unreliable, unaffordable, time-consuming, and not frequently updated. For example, by constantly determining or receiving new transaction data and automatically processing the data with a predictive model, classifications can be updated in real time, or substantially in real time. Furthermore, embodiments or aspects of the present invention provide the tools and systems for iteratively generating and sending communications to consumers, evaluating consumer security threats by comparing known consumer-associated classifications with hotel classifications, implementing suspensions of certain activities associated with a financial device, such as based upon rules associated with issuer institutions, and/or enrolling consumers in incentive or rewards programs. This provides the technical benefit of removing subjective human evaluation and providing a cost-effective means of lodging provider classification over a wide network of financial transactions.

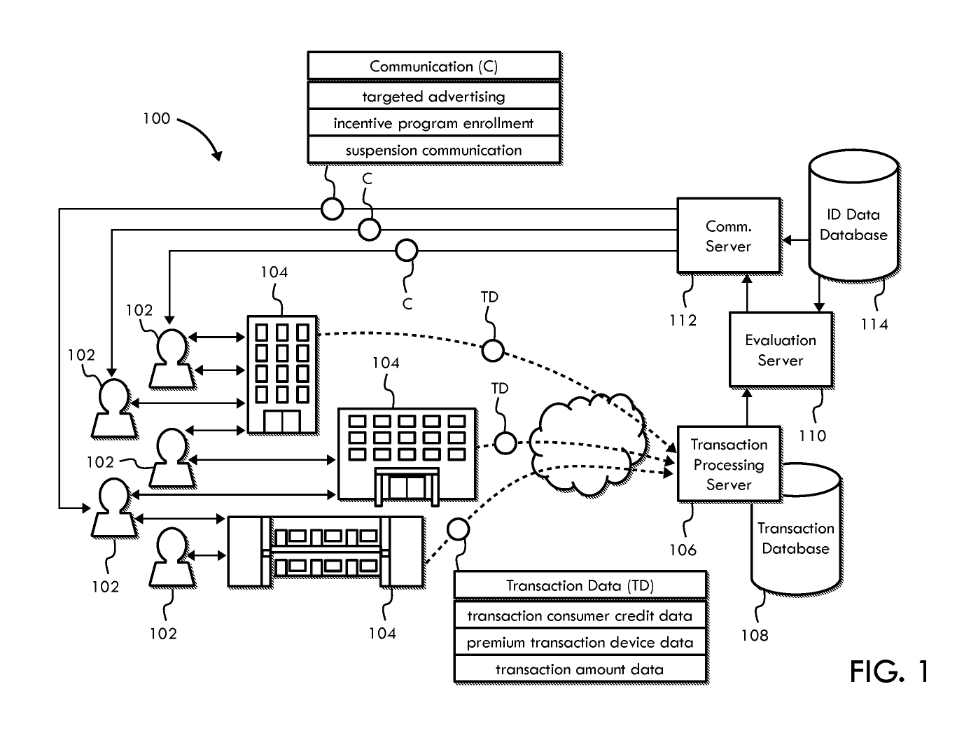

With specific reference to FIG. 1, and in one preferred and non-limiting embodiment or aspect, provided is a method and system 100 for automatically generating a classification of one or more lodging providers and acting thereon. The system includes one or more consumers, also herein called “financial device holders” 102, who are associated with one or more financial devices. Financial device holders 102 use their associated financial devices to complete one or more transactions with one or more lodging providers 104, principally through a merchant system. There may be a one-to-one, many-to-one, or many-to-many relationship between financial device holders 102 and financial devices, and between financial devices and lodging providers 104. The merchant systems of the lodging providers 104 communicate transaction data (TD) to a transaction processing server 106, having at least one processor, which may be associated with an issuing bank and/or a transaction service provider. Transaction data (TD) may include, but is not limited to, transaction consumer credit data, premium transaction device data, transaction amount data, and/or the like. The transaction processing server 106 is associated with a transaction database 108, in which transaction data (TD) can be stored, edited, deleted, retrieved, and/or the like. Transaction data (TD) may also be grouped or stored relationally to each lodging provider to generate and/or determine lodging provider-specific transaction data.

With further reference to FIG. 1, and in a further preferred and non-limiting embodiment or aspect, the transaction processing server 106 may communicate the transaction data (TD) to an evaluation server 110, having at least one processor, to assign at least one classification to a lodging provider associated with one or more transactions represented by the transaction data (TD). The evaluation server 110 may be the same server as the transaction processing server 106. The classification is selected through automated execution of a predictive model. The transaction data (TD) to be used in the predictive model (and specifically calculated per lodging provider 104) may include, but is not limited to, percent purchase volume on consumer credit, percent of transactions completed by premium financial device, average transaction amount, and/or the like. The predictive model may employ any appropriate statistical relationship analysis, such as multiple logistic regression. In the example of multiple logistic regression, the categorical lodging provider classification may be set as the dependent variable, and the calculated lodging-provider-specific parameters of the transaction data may be set as independent variables. Determining the contribution of individual parameters may be completed through an appropriate statistical coefficient contribution test, such as a likelihood ratio test, a Wald statistic, and/or the like. Evaluating the goodness of fit of the overall model may be completed through deviance tests, likelihood ratio tests, pseudo-R2 statistics, and/or the like. It will be appreciated that other statistical relationship models may be employed. The evaluation server 110 may be further communicatively connected to an identification data database 114 to receive or generate identification data of one or more financial device holders 102 associated with a transaction with an evaluated lodging provider 104. Identification data may include, but is not limited to, financial device holder name, financial device holder email address, financial device holder phone number, financial device holder physical address, financial device holder issuer institution, and/or the like. It will be appreciated that many other types of identification data and configurations are possible.

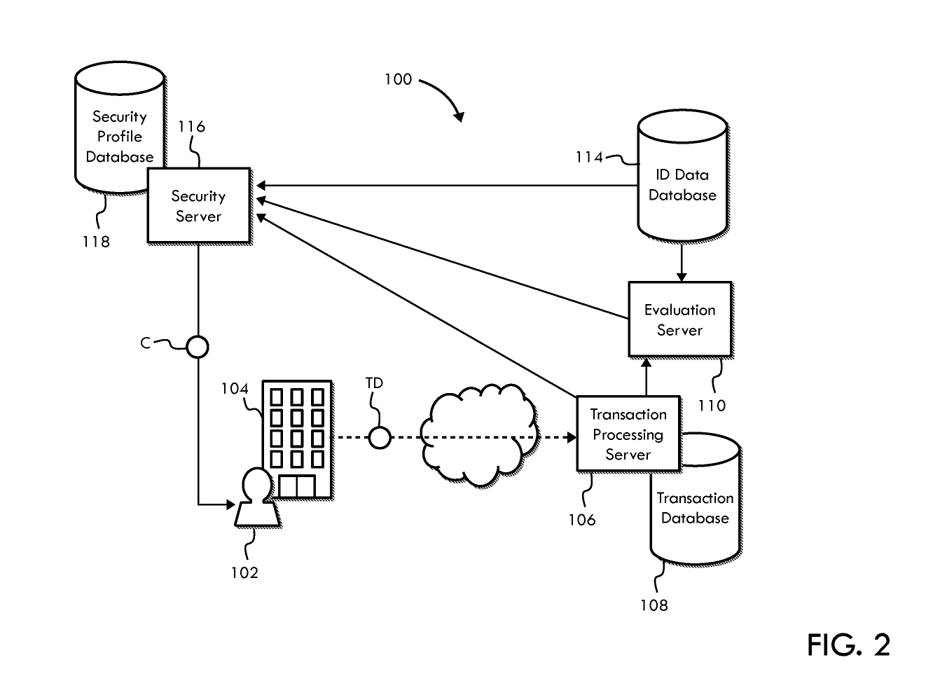

With further reference to FIG. 1, and in a further preferred and non-limiting embodiment or aspect, the evaluation server 110 transmits to a communication server 112 data of the one or more lodging provider 104 classifications. The evaluation server 110 may also communicate the identification data of one or more financial device holders 102 associated with a transaction with an evaluated lodging provider 104. The communication server 112 may also be the same server as the evaluation server 110 and/or the transaction processing server 106. In addition to or instead of the evaluation server 110 being in communicative connection with the identification data database 114, the communication server 112 may be communicatively connected to the identification data database 114 to receive or generate identification data of one or more financial device holders 102 associated with a transaction with an evaluated lodging provider 104. Having received or generated identification data from the evaluation server 110 and/or the identification data database 114, the communication server 112 generates and transmits at least one communication (C) to one or more financial device holders 102. For example, the communication (C) may be a text-based communication, such as an automatically generated email solicitation encouraging the financial device holder 102 to use their financial device for transactions with a given lodging provider 104. By way of further example, the communication (C) may be an issuer institution interface plug-in notification associated with a financial device such that a financial device holder 102 is displayed an offer or solicitation to use the financial device for certain types of lodging provider 104 transactions. The communication (C) may alternatively be an automated action by the issuer institution or transaction service provider to place the financial device holder 102 in an incentive rewards program, to encourage transactions with one or more lodging providers 104. Furthermore, the communication (C) may be an action to suspend a financial device account of a financial device holder 102, or a communication informing of such a suspension, based on detected fraudulent activity (further discussed in relation to FIG. 2). Given that the method and system 100 of the present invention may be iterative, communications (C) and/or the predictive model may be routinely modified. For example, the following may be modified with each iteration: the predictive model; an identity of the financial device holder 102 to be enrolled in the incentive program; the incentive program; an identity of the financial device holder 102 to be transmitted the communication; content of the communication; an identity of the financial device holder 102 to have an associated financial device suspended; the lodging-provider 104 classification associated with the financial device holder 102; a parameter or status of a suspension of the financial device; or any combination thereof. Other configurations are possible.

With specific reference to FIG. 2, and in one preferred and non-limiting embodiment or aspect, provided is a method and system 100 for automatically generating a classification of one or more lodging providers and acting thereon. Financial device holders 102 use their associated financial devices to complete one or more transactions with one or more lodging providers 104, principally through a merchant system. The merchant systems of the lodging providers 104 communicate transaction data (TD) to a transaction processing server 106, having at least one processor, which may be associated with an issuing bank and/or a transaction service provider. The transaction processing server 106 is associated with a transaction database 108, in which transaction data (TD) can be stored, edited, deleted, retrieved, and/or the like. The transaction processing server 106 may communicate the transaction data (TD) to an evaluation server 110, having at least one processor, to assign at least one classification to a lodging provider 104 associated with one or more transactions represented by the transaction data (TD). The evaluation server 110 may be the same server as the transaction processing server 106. The classification is selected through automated execution of a predictive model. The transaction data (TD) to be used in the predictive model may include, but is not limited to, percent purchase volume on consumer credit, percent purchase volume on small business credit, percent of transactions completed by premium financial device, average transaction amount, and/or the like. The evaluation server 110 may be further communicatively connected to an identification data database 114 to receive or generate identification data of one or more financial device holders 102 associated with a transaction with an evaluated lodging provider 104. It will be appreciated that other configurations and arrangements are possible.

With further reference to FIG. 2, and in a further preferred and non-limiting embodiment or aspect, the evaluation server 110 transmits to a security server 116 data of the one or more lodging provider 104 classifications. The evaluation server 110 may also communicate the identification data of one or more financial device holders 102 associated with a transaction with an evaluated lodging provider 104. The security server 116 may also be the same server as the evaluation server 110 and/or the transaction processing server 106. In addition to or instead of the evaluation server 110 being in communicative connection with the identification data database 114, the security server 116 may be communicatively connected to the identification data database 114 to receive or generate identification data of one or more financial device holders 102 associated with a transaction with an evaluated lodging provider 104. Having received or generated identification data from the evaluation server 110 and/or the identification data database 114, the security server 116 may evaluate and manage security profiles of financial device holders 102. Financial device holders 102 may be associated with a lodging provider 104 classification, which may represent an expected class of lodging provider 104 with which the financial device holder 102 will likely transact. Security profiles, and associated lodging provider 104 classifications, may be stored in a security profile database 118, with which the security server 116 can communicate. The security profile database 118 may also be the same database as the identification data database 114. If the security server 116 detects a financial device holder's 102 transaction with a lodging provider 104 having a class that is different, or significantly variant from, the financial device holder's 102 associated lodging provider 104 classification, then the security server may take a protective action, such as suspending the associated financial device, or its associated financial transaction account. A communication (C) may be sent from the security server 116 (or from a communication server) to a financial device holder 102 regarding the suspension or unsuspension of their associated financial device.

With further reference to FIGS. 1 and 2, the cyclical process within the system 100, in particular including the steps of determining or receiving transaction data (TD), assigning a classification, and taking an action, can be completed at configurable intervals. For example, the intervals may be scheduled at one or more times during a day or week, such as at regular times when network transaction traffic is lowest. The intervals may also be configured to be initiated in response to automatic or manual triggers within the system 100, such as the completion of one or more new transactions. In each interval, new transaction data (TD) may be collected and a new classification may be assigned to a lodging provider 104. The system 100 may compare the new classification to the previously assigned classification and take an action based on the comparison. For example, in each interval, the system 100 may take one or more of the following actions: modify the predictive model; modify the identity of the financial device holder 102 to receive a communication (C); modify the content of a communication; modify the identity of the financial device holder 102 to be enrolled or unenrolled in an incentive program; modify the incentive program; modify the identity of the financial device holder 102 to have a financial device suspended (for one or more actions or activities); modify a classification associated with a financial device holder 102; modify a parameter or status of a suspension of a financial device (or one or more suspended actions or activities); or any combination thereof.

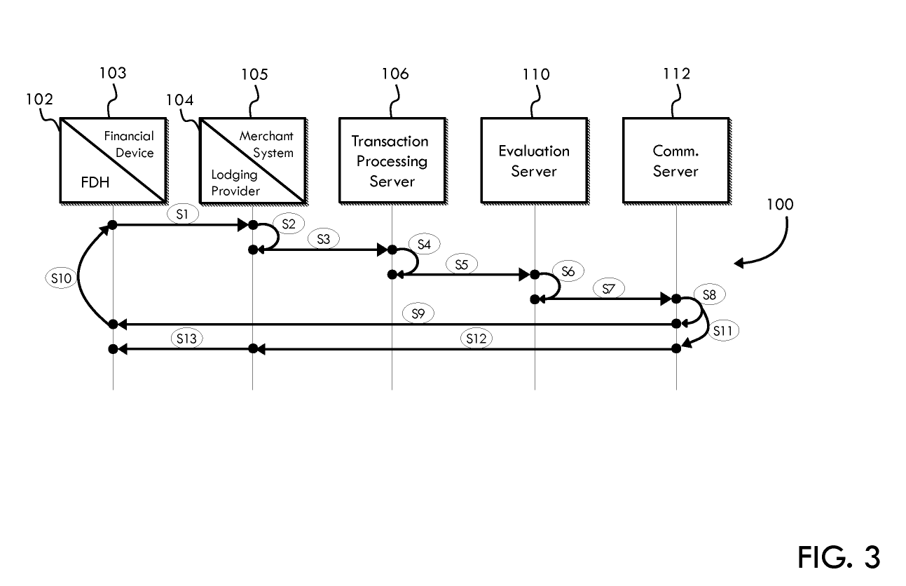

With specific reference to FIG. 3, and in one preferred and non-limiting embodiment or aspect, provided is a method and system 100 for automatically generating a classification of one or more lodging providers and acting thereon. Given that the method 100 may be a repeated or iterative process, it will be appreciated that the step labels (e.g., “step 1” depicted as S1) are for exemplary purposes to show general order and progression. The method 100 may be initiated at one or more locations in the process. At S1, a financial device holder 102 completes one or more transactions with the merchant system 105 of a lodging provider 104 via a financial device 103. It will be appreciated that there may be one or more financial device holders 102 completing one or more transactions with one or more merchant systems 105, using one or more financial devices 103. At S2, the merchant system 105 may analyze the transaction to determine an associated financial device holder 102, the identification data of which may have been provided to the merchant system 105 by the financial device holder 102 or by a communication server 112 that designated the financial device holder 102 as a target for advertising or incentive program enrollment. At S3 the merchant system 105 may communicate transaction data to a transaction processing server 106, the transaction data representative of the transaction completed during S1. For example, the merchant system 105 (e.g., point-of-sale system, online interface, etc.) may communicate automatically with the transaction processing server 106 in order to complete processing the transaction. At S4, the transaction processing server 106 may store the transaction data in a transaction database, and further, may store the transaction data relationally in association with each lodging provider to generate and/or determine lodging provider-specific parameters of the transaction data. The transaction data may be communicated to an evaluation server 110 at S5. Lodging provider-specific parameters of the transaction data may be generated and/or determined at the evaluation server 110 at S6. It will be appreciated that the transaction processing server 106 and the evaluation server 110 may be the same server. It will be appreciated that many configurations are possible.

With further reference to FIG. 3, and in a further preferred and non-limiting embodiment or aspect, the evaluation server 110 determines at S6 a lodging provider classification through automated execution of a predictive model. One or more financial device holders 102 may be associated with transactions with a given lodging provider 104, and identification data of the financial device holders 102 may be determined at S6 through communication with an identification data database 114. The assigned lodging provider classification, and optionally, the identification data of one or more financial device holders 102, may be communicated to a communication server 112 at S7. The communication server may be communicatively connected to an identification data database 114 instead of or in addition to the evaluation server 110, and, therefore, may pull identification data of one or more financial device holders 102 transacting with a given lodging provider 104. When one or more financial device holders 102 are determined to receive communications, the communication server 112 may generate a communication to the financial device holders 102 at S8 and transmit the communication to the financial device holders 102 at S9. The communication may be a message, including text-based communications (e.g., email, SMS, online messaging platforms, etc.), audio-based communications (e.g., voicemail, telephone calls, voice over internet protocol calls, mobile device sound alerts, etc.), video-based communications (e.g., still images, animated images, video files, etc.), or any combination thereof. The communication alternatively may be an automated action or a notification in a user interface for managing an associated financial device 103. At S10, a financial device holder 102 may take an action based on the communication from S9, such as transacting with a lodging provider 104, enrolling in an incentive program, completing a survey, selecting rewards, requesting the unsuspension of their financial device, and/or the like. It will be appreciated that many configurations are possible for communications to financial device holders 102, and actions thereon.

With further reference to FIG. 3, and in a further preferred and non-limiting embodiment or aspect, the communication server 112 may generate, in addition to or instead of a communication to the financial device holder 102, a communication to a merchant system 105 at S11, specifically, a merchant system 105 associated with a lodging provider 104 that has been classified by the predictive model. The communication server 112 may provide identification data of one or more financial device holders 102 to the merchant system 105 at S12 to allow the lodging provider 104 to send its own communication to the financial device holders 102 at S13. It will be appreciated that the financial device older 102 may be required to opt in to communications from merchant systems 105 before operating steps S11-S13. Moreover, it will be appreciated that steps S11-S13 may be carried out through an issuer institution instead of a lodging provider. For example, the communication server 112 may generate a communication at S11 including identification data of one or more financial device holders 102. The communication server 112 may then transmit the communication to an issuer institution that issued a financial device 103 associated with a financial device holder 102. The issuer institution may then transmit its own communication to the financial device holders 102 to incentivize transactions with one or more lodging providers 104. It will further be appreciated that communications from the communication server 112 to the financial device holder 102, the merchant system 105, and the issuer institution may be completed independently or in combination. Furthermore, it will be appreciated that the communication server 112 may be the same server as the evaluation server 110 and/or the transaction processing server 106. Other configurations are possible.

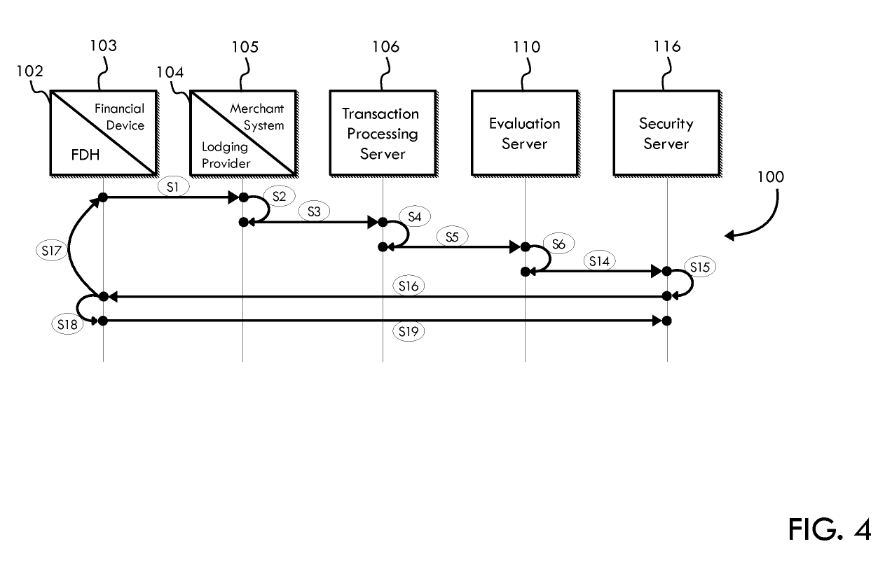

With specific reference to FIG. 4, and in one preferred and non-limiting embodiment or aspect, provided is a method and system 100 for automatically generating a classification of one or more lodging providers and acting thereon. Given that the method 100 may be a repeated or iterative process, it will be appreciated that the step labels are for exemplary purposes to show general order and progression. The method 100 may be initiated at one or more locations in the process. At S1, a financial device holder 102 completes one or more transactions with the merchant system 105 of a lodging provider 104 via a financial device 103. It will be appreciated that there may be one or more financial device holders 102 completing one or more transactions with one or more merchant systems 105, using one or more financial devices 103. At S2, the merchant system 105 may analyze the transaction to determine an associated financial device holder 102, the identification data of which may have been provided to the merchant system 105 by the financial device holder 102 or by a communication server 112 that designated the financial device holder 102 as a target for fraudulent transaction activity. At S3 the merchant system 105 may communicate transaction data to a transaction processing server 106, the transaction data representative of the transaction completed during S1. For example, the merchant system 105 (e.g., point-of-sale system, online interface, etc.) may communicate automatically with the transaction processing server 106 in order to complete processing the transaction. At S4, the transaction processing server 106 may store the transaction data in a transaction database, and further, may store the transaction data relationally in association with each lodging provider to generate and/or determine lodging provider-specific parameters of the transaction data. The transaction data may be communicated to an evaluation server 110 at S5. Lodging provider-specific parameters of the transaction data may be generated and/or determined at the evaluation server 110 at S6. It will be appreciated that the transaction processing server 106 and the evaluation server 110 may be the same server. It will be appreciated that many configurations are possible.

With further reference to FIG. 4, and in a further preferred and non-limiting embodiment or aspect, the evaluation server 110 assigns at S6 a lodging provider classification through automated execution of a predictive model. One or more financial device holders 102 may be associated with transactions with a given lodging provider 104, and identification data of the financial device holders 102 may be determined at S6 through communication with an identification data database 114. A classification of a lodging provider 104 may be associated with one or more financial devices 103 that have completed at least one transaction with the lodging provider 104 (also called a “user-associated classification”). The user-associated classification may be used as part of a security profile or security protection system to detect fraudulent card activity. The user-associated classification may be stored in association with the financial device holder 102, or in association with the financial device 103 itself. For example, at S6, a previously assigned user-associated classification may be compared to a newly assigned lodging provider classification, and, if the classifications differ or are significantly variant, the evaluation server may determine that the financial device 103 is being used fraudulently. The assigned lodging provider classification, and, optionally, the identification data and/or the security profile of one or more financial device holders 102, may be communicated to a security server 116 at S14. The security server 116 may be communicatively connected to an identification data database 114 instead of or in addition to the evaluation server 110, and, therefore, may pull identification data of one or more financial device holders 102 transacting with a given lodging provider 104. The security server 116 may additionally be communicatively connected to a security profile database, where the user-associated classification may be stored. At S15, the security server may compare the user-associated classification to the assigned lodging provider 104 classification and determine that the financial device is being used fraudulently, and it may, thereby update the associated security profile. Alternatively, the security server 116 may use the determination of fraudulent activity from the evaluation server 110 to update the security profile of the associated financial device holder 102 and/or financial device 103. At S15, the security server 116 may take one or more actions based on the comparison to the lodging provider 104 classification, such as suspending a financial device 103, unsuspending a financial device 103, flagging a financial device 103 for further monitoring, or updating the parameters of a security profile. Other configurations are possible.

With further reference to FIG. 4, and in a further preferred and non-limiting embodiment or aspect, when one or more financial devices 103 are determined to have engaged in fraudulent activity, based at least on the comparison to the assigned lodging provider 104 classification, the security server 116 (or alternatively, a communication server 112) may additionally generate a communication at S15 and transmit the communication at S16 to the associated financial device holder 102. In this way, the financial device holder 102 is notified of the action taken by the security server 116, such as suspending the financial device holder's 102 financial device 103, unsuspending the financial device 103, and/or the like. The financial device holder 102 may then take an action at S18, such as generate a response communication, which may be then transmitted at S19. A response communication may affirm or deny the detected fraudulent activity, or provide a means for the financial device holder 102 to request more information. As used herein, suspension of a financial device 103 may include suspension of the all activity by the financial device 103, or a subset of one or more activities or actions. For example, a suspension may be based on one or more of the following activities: completing a transaction of a prohibited type (e.g., online transactions, services transactions, person-to-person transactions, etc.); completing a transaction of a prohibited amount (e.g., exceeding $100 in a single purchase); completing a transaction with a prohibited merchant (e.g., a distant merchant, a differently classed merchant, a security-risk-prone merchant, etc.); or any combination thereof. The security server 116 may also automatically initiate one or more other security actions, in addition to or instead of suspension, such as: generating and transmitting an alert communication to an issuer institution associated with the at least one financial device holder; generating and transmitting an alert communication to the at least one financial device holder 102; or any combination thereof. Security actions, including suspensions and communications, may be based on one or more predetermined issuer institution rules. It will be appreciated that many configurations are possible.

With further reference to the foregoing figures, one or more servers in the system 100 may employ one or more automatic processes for retrieving transaction data, associating transactions with lodging providers 104, determining lodging provider-specific parameters based on the transaction data, and assigning a lodging provider 104 classification based on the determination. For example, the predictive model may assign a lodging provider 104 classification based on a determination of percent consumer credit purchase volume. To do so, at least one processor may determine a total purchase volume and a consumer credit purchase volume of the at least one lodging provider 104 in the first time period. The at least one processor may determine, based on a proportion of the consumer credit purchase volume relative to the total purchase volume, a percent consumer credit purchase volume. The processor may assign a lodging provider 104 classification based on inputting the percent consumer credit purchase volume into the predictive model, such as by logistic regression. Alternatively, the predictive model may have already output predetermined ranges of percent consumer credit purchase volume that are indicative of distinct lodging provider classifications, based on an analysis of historic transaction data. For example, it may be known that approximately 40% or less of purchase volume that is made on consumer credit is indicative of “economy class”. A determined percent consumer credit purchase volume in that range may be assigned the “economy class” classification. It will be appreciated that other configurations are possible.

With further reference to the foregoing figures, and by way of further example, the predictive model may assign a lodging provider 104 classification based on a determination of percent premium financial device purchase volume. To do so, at least one processor may determine a total purchase volume and a premium financial device purchase volume of the at least one lodging provider 104 in the first time period. The at least one processor may determine, based on a proportion of the premium financial device purchase volume relative to the total purchase volume, a percent premium financial device purchase volume. The processor may assign a lodging provider 104 classification based on inputting the percent premium financial device purchase volume into the predictive model, such as by logistic regression. Alternatively, the predictive model may have already output predetermined ranges of percent premium financial device purchase volume that are indicative of distinct lodging provider classifications, based on an analysis of historic transaction data. For example, it may be known that approximately 45% or more of purchase volume that is made by premium financial device is indicative of “luxury class”. A determined percent premium financial device purchase volume in that range may be assigned the “luxury class” classification. It will be appreciated that other configurations are possible.

With further reference to the foregoing figures, and by way of further example, the predictive model may assign a lodging provider 104 classification based on a determination of average transaction amount. To do so, at least one processor may determine a total purchase volume and a total number of transactions of the at least one lodging provider 104 in the first time period. The at least one processor may determine, based on a proportion of the total purchase volume to the total number of transactions, an average transaction amount. The processor may assign a lodging provider 104 classification based on inputting the average transaction amount into the predictive model, such as by logistic regression. Alternatively, the predictive model may have already output predetermined ranges of average transaction amount that are indicative of distinct lodging provider classifications, based on an analysis of historic transaction data. For example, it may be known that an average transaction amount of approximately $200 is indicative of “midscale class”. A determined average transaction amount in that range may be assigned the “midscale class” classification. It will be appreciated that other configurations are possible.

Although the invention has been described in detail for the purpose of illustration based on what is currently considered to be the most practical and preferred and non-limiting embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for automatically generating a classification of at least one lodging provider and acting thereon, the method comprising:
(a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof;
(b) assigning, with at least one processor and based at least partially on a predictive model and the transaction data, a classification to the at least one lodging provider, the classification being selected from a plurality of predetermined classifications;
(c) generating, with at least one processor and based at least partially on the assigned classification, identification data of at least one financial device holder of the plurality of financial device holders; and
(d) automatically generating and transmitting, with at least one processor, at least one communication to the at least one financial device holder.

2. The computer-implemented method of claim 1, further comprising:
(e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof;
(f) assigning, with at least one processor and based at least partially on the predictive model and the new transaction data, a new classification to the at least one lodging provider, the new classification being selected from the plurality of predetermined classifications;
(g) comparing, with at least one processor, the new classification to the previously assigned classification; and
(h) modifying, with at least one processor and based at least partially on the comparison, at least one of the following: the predictive model, an identity of the at least one financial device holder to be transmitted the at least one communication, content of the at least one communication, or any combination thereof.

3. The computer-implemented method of claim 2, wherein step (h) comprises modifying the identity of the at least one financial device holder to be transmitted the at least one communication and/or the content of the at least one communication, and wherein the method further comprises (i) automatically generating and transmitting, with at least one processor, at least one new communication to the at least one financial device holder.

4. The computer-implemented method of claim 3, comprising repeating steps (e)-(i) at configurable intervals.

5. The computer-implemented method of claim 1, wherein the at least one communication is a suspension notice communication representative of a suspension of at least one activity associated with at least one financial device of the at least one financial device holder, the at least one activity comprising at least one of the following: a transaction of a prohibited type, a transaction of a prohibited amount, a transaction with a prohibited merchant, or any combination thereof.

6. The computer-implemented method of claim 1, wherein the plurality of predetermined classifications comprises at least one of the following: economy class, midscale class, upper midscale class, upscale class, upper upscale class, luxury class, or any combination thereof.

7. The computer-implemented method of claim 1, wherein step (b) comprises:
determining, with at least one processor, a total purchase volume of the at least one lodging provider in the first time period;
determining, with at least one processor, a consumer credit purchase volume of the at least one lodging provider in the first time period;
determining, with at least one processor and based on a proportion of the consumer credit purchase volume relative to the total purchase volume, a percent consumer credit purchase volume; and
assigning, with at least one processor and based at least partially on the percent consumer credit purchase volume, the classification to the at least one lodging provider.

8. The computer-implemented method of claim 1, wherein step (b) comprises:
determining, with at least one processor, a total purchase volume of the at least one lodging provider in the first time period;
determining, with at least one processor, a premium financial device purchase volume of the at least one lodging provider in the first time period;
determining, with at least one processor and based on a proportion of the premium financial device purchase volume relative to the total purchase volume, a percent premium financial device purchase volume; and
assigning, with at least one processor and based at least partially on the percent premium financial device purchase volume, the classification to the at least one lodging provider.

9. The computer-implemented method of claim 1, wherein step (b) comprises:
determining, with at least one processor, a total purchase volume of the at least one lodging provider in the first time period;
determining, with at least one processor, a total number of transactions of the at least one lodging provider in the first time period;
determining, with at least one processor and based on a proportion of the total purchase volume relative to the total number of transactions, an average transaction amount; and
assigning, with at least one processor and based at least partially on the average transaction amount, the classification to the at least one lodging provider.

10. A computer-implemented method for automatically generating a classification of at least one lodging provider and acting thereon, the method comprising:
(a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof;
(b) assigning, with at least one processor and based at least partially on a predictive model and the transaction data, a classification to the at least one lodging provider, the classification being selected from a plurality of predetermined classifications;
(c) generating, with at least one processor and based at least partially on the assigned classification, identification data of at least one financial device holder of the plurality of financial device holders; and
(d) automatically enrolling, with at least one processor, the at least one financial device holder in at least one incentive program.

11. The computer-implemented method of claim 10, further comprising:
(e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof;
(f) assigning, with at least one processor and based at least partially on the predictive model and the new transaction data, a new classification to the at least one lodging provider, the new classification being selected from the plurality of predetermined classifications;
(g) comparing, with at least one processor, the new classification to the previously assigned classification; and
(h) modifying, with at least one processor and based at least partially on the comparison, at least one of the following: the predictive model, an identity of the at least one financial device holder to be enrolled in the at least one incentive program, the at least one incentive program, or any combination thereof.

12. The computer-implemented method of claim 11, wherein step (h) comprises modifying the identity of the at least one financial device holder to be enrolled in the at least one incentive program and/or the at least one incentive program, and wherein the method further comprises (i) automatically enrolling or unenrolling, with at least one processor, the at least one financial device holder in the at least one incentive program.

13. The computer-implemented method of claim 12, comprising repeating steps (e)-(i) at configurable intervals.

14. The computer-implemented method of claim 10, wherein the plurality of predetermined classifications comprises at least one of the following: economy class, midscale class, upper midscale class, upscale class, upper upscale class, luxury class, or any combination thereof.

15. A computer-implemented method for automatically generating a classification of at least one lodging provider and acting thereon, the method comprising:
(a) determining or receiving, with at least one processor, transaction data representative of a plurality of transactions between the at least one lodging provider and a plurality of financial device holders in a first time period, the transaction data comprising at least one of the following: transaction consumer credit data, premium transaction device data, transaction amount data, or any combination thereof;
(b) assigning, with at least one processor and based at least partially on a predictive model and the transaction data, a classification to the at least one lodging provider, the classification being selected from a plurality of predetermined classifications;
(c) generating, with at least one processor and based at least partially on the assigned classification, identification data of at least one financial device holder of the plurality of financial device holders, the at least one financial device holder having a user-associated classification that is different from the assigned classification; and
(d) automatically initiating, with at least one processor, at least one security action comprising at least one of the following: generating and transmitting an alert communication to an issuer institution associated with the at least one financial device holder; generating and transmitting an alert communication to the at least one financial device holder; suspending at least one activity associated with at least one financial device of the at least one financial device holder; or any combination thereof.

16. The computer-implemented method of claim 15, further comprising:
(e) determining or receiving, with at least one processor, new transaction data representative of a plurality of transactions between the at least one lodging provider and a plurality of financial device holders in a second time period, the new transaction data comprising at least one of the following: transaction consumer credit data, premium transaction device data, transaction amount data, or any combination thereof;
(f) assigning, with at least one processor and based at least partially on the predictive model and the new transaction data, a new classification to the at least one lodging provider, the new classification being selected from the plurality of predetermined classifications;
(g) comparing, with at least one processor, the new classification to the previously assigned classification; and
(h) modifying, with at least one processor and based at least partially on the comparison, at least one of the following: the predictive model, an identity of the at least one financial device holder to have an associated financial device suspended, the user-associated classification, a parameter or status of a suspension of the at least one financial device, or any combination thereof.

17. The computer-implemented method of claim 16, wherein step (h) comprises modifying the identity of the at least one financial device holder to have an associated financial device suspended and/or the parameter or status of a suspension of the at least one financial device, and wherein the method further comprises (i) automatically suspending or unsuspending, with at least one processor, at least one activity of the at least one financial device of the at least one financial device holder.

18. The computer-implemented method of claim 17, comprising repeating steps (e)-(i) at configurable intervals.

19. The computer-implemented method of claim 15, wherein the plurality of predetermined classifications comprises at least one of the following: economy class, midscale class, upper midscale class, upscale class, upper upscale class, luxury class, or any combination thereof.

20. The computer-implemented method of claim 15, wherein the at least one activity comprises at least one of the following: a transaction of a prohibited type, a transaction of a prohibited amount, a transaction with a prohibited merchant, or any combination thereof.
